(19) United States
(12) Patent Application Publication
(10) Pub. No.: US 2014/0042866 A1
(43) Pub. Date: Feb. 13, 2014

(54) MOTOR CORE COMPONENT AND METHOD FOR INCREASING MATERIAL UTILIZATION AND SLOT FILL RATIO THEREOF

(71) Applicant: Johnson Electric S.A., Murten (CH)

(72) Inventors: Jian ZHAO, Shenzhen (CN); Baoting LIU, Shenzhen (CN); Haihui XIANG, Shenzhen (CN); Yaming ZHANG, Shenzhen (CN); Yong LI, Shenzhen (CN); Zenghui WU, Shenzhen (CN)

(73) Assignee: Johnson Electric S.A., Murten (CH)

(21) Appl. No.: 13/963,582

(22) Filed: Aug. 9, 2013

(30) Foreign Application Priority Data
Aug. 10, 2012 (CN) 201210284524.9

(51) Int. Cl. H02K 1/14; H02K 15/02

(52) U.S. Cl. CPC H02K 1/148; H02K 15/02
USPC 310/216.007; 29/598

(57) ABSTRACT

A motor core component (10) comprising a plurality of poles (12) and an annular or ring-shaped yoke (16). The yoke (16) is manufacturing by bending or folding a belt component (26) comprising a plurality of yoke portions (14), allowing for greater material utilization during production. At least a portion of the poles (20) are a separate component from the yoke portions (14), such that field coils may be wound around the pole bodies (18) prior to assembling the poles (12) and yoke (16) together, thereby allowing for more convenient winding and a higher slot fill ratio.

### CROSS REFERENCE TO RELATED APPLICATION(S)

This application claims the benefit of Chinese patent application serial no. 201210284524.9, which was filed on Aug. 10, 2012. The entire content of the aforementioned patent application is hereby incorporated by reference for all purposes.

### BACKGROUND

Electric motor rotors and stators often comprise one or more core components stacked together. These core components typically comprise a yoke and a plurality of poles or teeth (for attaching one or more magnetic components, such as field coil windings. For example, in many motors, adjacent pairs of poles attached to a stator yoke may define winding slots, allowing for field coils to be wound around each of the poles.

Motor core components may be manufactured as a single component. For example, FIG. 1 illustrates a production pattern for a plurality of motor core components 6 comprising a central yoke and a plurality of outward extending poles, wherein each of the core components is made of a single solid piece 2 cut, carved, or otherwise manufactured from a material sheet 4, which may be a metal, plastic, or any other material suitable for manufacturing a motor core component. However, as illustrated in FIG. 1, the material utilization using this type of configuration is low, with a large percentage of the material going to waste. This leads to greater material consumption and higher operating costs for manufacturers.

In addition, a single-piece configuration may limit the amount of field coil windings that are able to be wrapped around the poles, due to the need to leave space on the pole for the winding to stitch in and out. In some applications, it is desirable to be able to fit many field coil windings within the winding slots of the core component to achieve a high slot fill ratio, as doing so allows the field coils to generate a stronger magnetic field, allowing for greater output torque. Single-piece core components may be unable to achieve a sufficient slot fill ratio for some of these applications.

Thus, there exists a need for a core component for a motor with increased material use ratio and higher slot fill ratio.

### SUMMARY

Some embodiments are directed at a motor core component that may be manufactured with increased material utilization and having a higher slot fill ratio. Some embodiments comprise a yoke formed from one or more belt components comprising a plurality of linearly connected yoke portions. The core component also comprises a plurality of poles upon which a plurality of field coils may be wound or attached. In some embodiments, a portion of the poles are separate components from the yoke. The belt components and separate pole portions may be configured so that a higher material utilization may be achieved during manufacturing. Field coils may be wrapped around the poles of the core component before attaching the yoke to the separate pole portions, allowing for more convenient winding and a higher slot fill ratio.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 illustrates a production pattern for a plurality of motor core components.

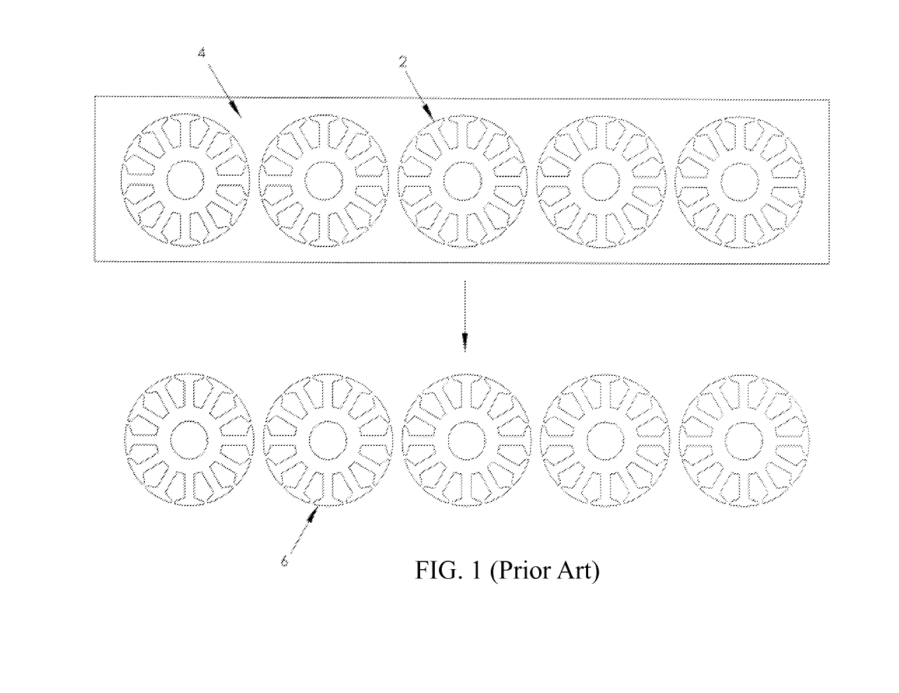

FIG. 2A illustrates a motor core component in accordance with some embodiments.

FIG. 2B illustrates a magnified view of the circled portion of the motor core component illustrated in FIG. 2A.

FIG. 3 illustrates a production pattern for a belt component in accordance with some embodiments.

FIG. 4 illustrates a production pattern for a plurality of poles in accordance with some embodiments.

FIG. 5 illustrates a motor core component in accordance with some embodiments.

FIG. 6 illustrates a production pattern for a belt component in accordance with some embodiments.

FIG. 7 illustrates a production pattern for a plurality of poles in accordance with some embodiments.

FIG. 8 illustrates a motor in accordance with some embodiments.

### DETAILED DESCRIPTION

Various features are described hereinafter with reference to the figures. It shall be noted that the figures are not drawn to scale, and that the elements of similar structures or functions are represented by like reference numerals throughout the figures. It shall also be noted that the figures are only intended to facilitate the description of the features for illustration and explanation purposes, unless otherwise specifically recited in one or more specific embodiments or claimed in one or more specific claims. The drawings figures and various embodiments described herein are not intended as an exhaustive illustration or description of various other embodiments or as a limitation on the scope of the claims or the scope of some other embodiments that are apparent to one of ordinary skills in the art in view of the embodiments described in the Application. In addition, an illustrated embodiment need not have all the aspects or advantages shown.

An aspect or an advantage described in conjunction with a particular embodiment is not necessarily limited to that embodiment and may be practiced in any other embodiments, even if not so illustrated, or if not explicitly described. Also, reference throughout this specification to “some embodiments” or “other embodiments” means that a particular feature, structure, material, process, or characteristic described in connection with the embodiments is included in at least one embodiment. Thus, the appearances of the phrase “in some embodiments”, “in one or more embodiments”, or “in other embodiments” in various places throughout this specification are not necessarily referring to the same embodiment or embodiments.

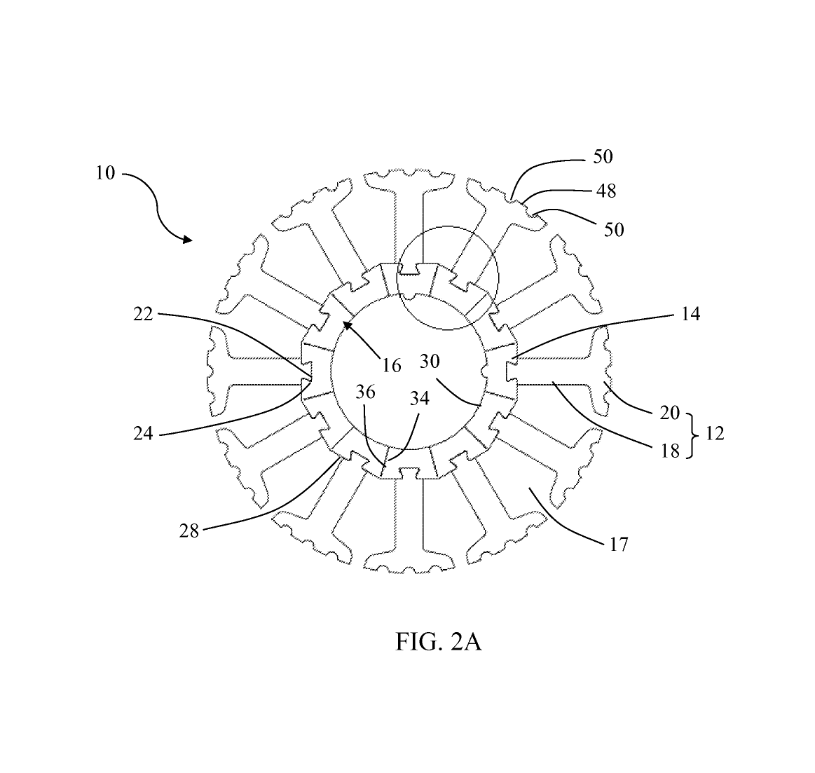

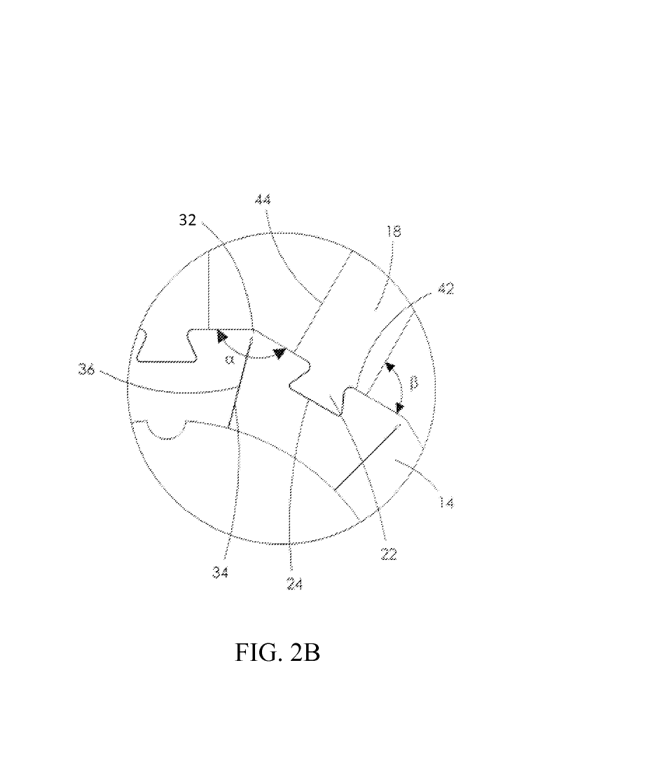

Embodiments are directed at a core component (collectively motor core component hereinafter) of a rotatory device including an electric motor or a generator. A core component may comprise separately assembled components to allow for increased material utilization and to achieve a higher slot fill ratio. In some embodiments, a slot fill ratio represents a ratio of the space (e.g., length of a pole) available for or actually receiving windings and a total space with a specific piece of manufacturing equipment. In these embodiments, various embodiments described herein may allow for a higher slot fill ratio by using the same specific piece of manufacturing equipment without customizations for the manufacturing equipment or decrease in performance of the manufacturing equipment. For example, some of these embodiments enable the use of the same equipment to produce windings around a pole without customizing the commonly used manufacturing equipment or decrease in, for example but not limited to, yield or production rate of the manufacturing equipment. In some embodiments, the core component comprises a substantially annular, circular, or axis-symmetric (hereinafter annular) yoke and a plurality of poles. It shall be noted that the term “annular” such as in the aforementioned “annular yoke” is used herein to indicate any component that is substantially circular or ring-shaped. It is not necessary for an annular component to be perfectly circular. For example, a yoke 16 as illustrated in FIG. 2A is considered annular even though the surfaces of the yoke portions 14 (such as outer surfaces 28) may be flat surfaces.

The annular or axis-symmetric yoke may comprise a plurality of yoke portions. The plurality of yoke portions may be manufactured by starting with a belt- or chain-like component (collectively a belt component) which may be further bent, folded, rolled, or by any other suitable manufacturing processes to form the annular or axis-symmetric yoke. By manufacturing the yoke portions as a belt component rather than machining the entirety or a substantial portion of the yoke from a single piece of material to achieve desired dimensions while removing unneeded material, a higher material utilization may be achieved.

In some embodiments, a yoke portion comprises a separate component from a portion of the poles and may be a single, inseparable piece of component (e.g., by machining, welding, or any other manufacturing processes for joining materials together) or a separably assembled assembly of multiple parts. In some embodiments, the field coils may be wrapped around the poles before they are attached to the yoke portions. This type of configuration may allow for more convenient winding and achieve a higher slot fill ratio for the same pole design that is manufactured with conventional approaches such as manufacturing a pole from the same piece of material that is used to manufacture the yoke.

FIG. 2A illustrates a motor core component 10 in accordance with some embodiments. FIG. 2B illustrates a magnified view of the substantially circular portion of motor core component 10 of FIG. 2A. While the illustrated embodiment depicts a core component for a stator in an inner stator/outer rotor motor, it is understood by those skilled in the art that the same concepts may be applied to other types of motors as well, including outer stator/inner rotor motors. It shall be noted that the term “substantially” or “substantial” such as in the aforementioned “substantially circular portion” is used herein to indicate that certain features, although designed or intended to be perfect (e.g., perfectly circular), the fabrication or manufacturing tolerances, the slacks in various mating components or assemblies due to design tolerances or normal wear and tear, or any combinations thereof may nonetheless cause some deviations from this designed, perfect characteristic. Therefore, one of ordinary skill in the art will clearly understand that the term “substantially” or “substantial” is used here to incorporate at least such fabrication and manufacturing tolerances, the slacks in various mating components or assemblies, or any combinations thereof.

As illustrated in FIG. 2A, motor core component 10 comprises an annular, ring-shaped, circular, or axis-symmetric yoke 16 (collectively annular) and a plurality of poles 12. Annular yoke 16 comprises a plurality of yoke portions 14. In the illustrated embodiment, poles 12 constitute separate components from the yoke portions 14 and are separably or inseparably attached to the yoke portions 14. It shall be noted that a “separate component” as used herein may indicate a component that is manufactured separately and is later attached, assembled, or fixed onto another component.

In some embodiments, the poles 12 are attached to the outer surfaces of the yoke portions 14, facing radially outwards from the center of annular yoke 16. For the purposes of this specification, an inner surface is construed to refer to a surface of a portion or component closer to the center of the assembled core component, while an outer surface refers to a surface of the portion or component further away from the center of the assembled core component in some embodiments.

In some embodiments, pairs of adjacent poles 12 define a winding slot 17 for accommodating a magnetic component including, for example but not limited to, a field coil. In some embodiments, winding slot 17 may comprise a groove, channel, or other structural feature(s) capable of housing a magnetic component. The magnetic component may comprise a field coil, which may be wound around pole 12 to occupy at least some of the space within the winding slot 17. It shall be noted that although a field coil may theoretically occupy the entire available space provided by the winding slot 17, practical concerns or limitations (e.g., ease of access, throughput requirement, etc.) may nonetheless leave some of the available space unused. For example, the manufacturing equipment for producing the windings may not be able to route the coils to occupy the space near one or both ends of the winding slot 17 due to, for example, blockage by the presence of other component(s), operating range of motion of the equipment, etc. and hence limited access to such space. Field coils may refer to any electromagnet or other device capable of generating a magnetic field when driven by an electric current. In some embodiments, the field coils comprise aluminum coils, copper coils, silver coils, or any combinations thereof.

A pole 12 may comprise a pole body 18 and a pole shoe 20. In some embodiments, the pole shoe 20 is located at an outer end of the pole body 18, and extends in the circumferential direction on both sides of the pole body 18. It will be understood that in other embodiments, pole shoe 20 may take on a variety of shapes and forms different from those illustrated in the figures.

The opposite end of pole body 18 may comprise structural or connection features to attach pole 12 to corresponding structural or connection features on a yoke portion 14. For example, in the embodiment illustrated in FIGS. 2A and 2B, an inner surface of pole body 18 comprises a protrusion 22, while an outer surface of yoke portion 14 comprises a corresponding indentation 24 (such as a hole, slot, groove of any profiles, or other structural feature(s)), such that pole 12 may be attached to yoke portion 14 by fitting protrusion 22 within indentation 24. It will be understood by those skilled in the art that other types of structural or connection features to connect pole body 18 and yoke portion 14 may also be used. For example, in some configurations, pole body 18 may instead include the indentation, and yoke portion 14 the corresponding protrusion. In some other configurations, a pole may be attached to the yoke by using other ways of joining two components such as the use of various types of fasteners, welding, brazing, etc.

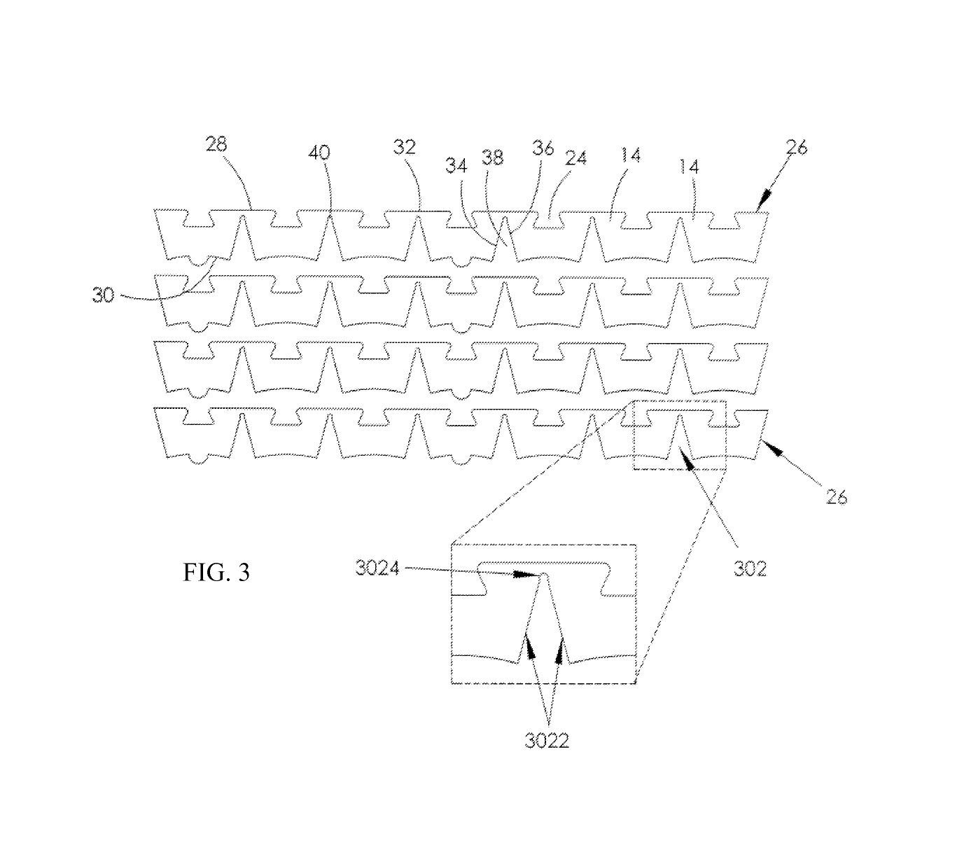

In some embodiments, the yoke 16 is assembled using a belt or chain like component 26 (shown in FIG. 3) that is bent, folded, rolled, or otherwise formed into a substantially circular or ring shape. It is understood that a belt or chain like component may refer to any component comprising a plurality of yoke portions 14 attached linearly that may be bent, folded, rolled, deformed, or otherwise formed into an annular yoke 16. In some embodiments, component 26 may comprise a single, inseparable piece of material that is manufactured out of a single piece of material by, for example, machining. In these embodiments, component 26 may comprise one or more structural stabilizing features or one or more field stabilizing features 302 (collectively structural stabilizing features or structural stabilizing feature) on the surface opposite to the surface on which multiple poles 12 may be disposed. More specifically, the structural stabilizing feature 302 may be formed based at least in part upon some dimensions (e.g., the outer diameter or the inner diameter) of the yoke 16 such that some characteristics of the structural stabilizing feature (e.g., characteristics 3022) may ease the manufacturing of the final shape of the yoke 16. In some embodiments, the one or more structural stabilizing features may also act as stress relief features to relieve the stresses (e.g., compressive stresses, shear stresses, or tensile stresses) in the yoke 16 due to bending in forming the final shape of the yoke 16. The one or more structural stabilizing features may also help stabilize the magnetic field in the final product due to the reduced stress levels so the yoke 16 has more stable dimensions due to its reduced stress level and may thus be called field stabilizing features. In some embodiments, a structural stabilizing feature may further comprise an additional stress relief feature 3024 to further relieve stress concentration in the vicinity of 3024. The additional stress relief feature 3024 may comprise an aperture having a larger diameter or larger dimension to alleviate stress concentration or to improve the life, reliability, or robustness of the yoke 16 due to the reduced stress level. The actual dimensions of the additional stress relief feature 3024 may be determined based at least in part upon the dimensions or performance requirement(s) of the yoke 16, the operational requirement(s) for the yoke 16, or any combinations thereof. In some of these embodiments, characteristics 3022 may act as a hard stop (e.g., by virtue of the compressive strength of the material for the yoke portion 14) in forming the final configuration of the yoke 16 such as the configuration illustrated in FIG. 2A. Nonetheless, it shall be noted that the two characteristic surfaces 3022 are not necessarily required to contact each other in the final configuration of the yoke 16 in some embodiments. In some other the structural embodiments, component 26 may comprise multiple individual yoke portions 14 that are assembled together via mechanical means (e.g., fasteners) to form component 26. In some embodiments, the manufacturing processes to produce various components or the final product may comprise one or more stress relief processes such as a heat treatment process that heats these various components or final product below their respective lower critical temperatures and then follows with a substantially uniform, controlled cooling process to reduce the internal stresses created during the manufacturing of these components or the final product.

FIG. 3 illustrates a production pattern for a plurality of belt components 26 in accordance with some embodiments. In some embodiments, a yoke 16 may be formed from a single belt component 26. However, in other embodiments, a yoke 16 may comprise multiple belt components 26 attached together by using, for example, various types of suitable fasteners. As can be seen in FIG. 3, the use of belt components 26 to form yoke 16 allows for more efficient material utilization during manufacturing, leading to lower production costs, as the belt components 26 may be arranged in a more compact pattern, allowing for less waste of the material in producing components 26.

Belt component 26 comprises a plurality of yoke portions 14 attached through a plurality of connection portions 32 in some embodiments. In some embodiments, connection portion 32 is located near outer surface 28 of adjacent yoke portions 14. Each pair of adjacent yoke portions 14 may be separated by a notch 38 defined by joint surfaces 34 and 36 extending between connection portion 32 and inner surface 30. In some embodiments, to form yoke 16, belt component 26 is bent, folded, or rolled at the connection portions 32, such that each pair of joint surfaces 34 and 36 are made to align with and contact each other, closing notch 38. It shall be noted that although each yoke portion 14 in FIG. 3 may appear to be identical, the plurality of yoke portions do not necessarily have to be identical in some other embodiments.

In some embodiments, a through hole or aperture 40 may be optionally located near the meeting point of each pair of joint surfaces 34 and 36, adjacent to connection portion 32. In some embodiments, through hole 40 may function to reduce the concentration of stress in a belt component 26, helping to prevent failure or breakage near the connection portion 32 when belt component 26 is bent, rolled, or folded into yoke 16. The through hole or aperture 40 may function as an additional stress relief feature 3024 described above.

In some embodiments, belt component 26 is configured so that the outer surfaces 28 of the yoke portions 14 are on substantially the same plane, with slots 24 or other connection feature(s) for attaching pole 12 to yoke portion 14 located on the outer surface 28 of each yoke portion 14. In some embodiments, the outer surface 28 of a yoke portion 14 need not be a flat surface and may define a surface of any shapes or profiles. In some embodiments, the inner surfaces 30 of the yoke portions 14 are configured to define a concave arcuate or curved surface such that when belt component 26 is formed into yoke 16, the inner surfaces 30 of the plurality of yoke portions 14 may define a circular perimeter.

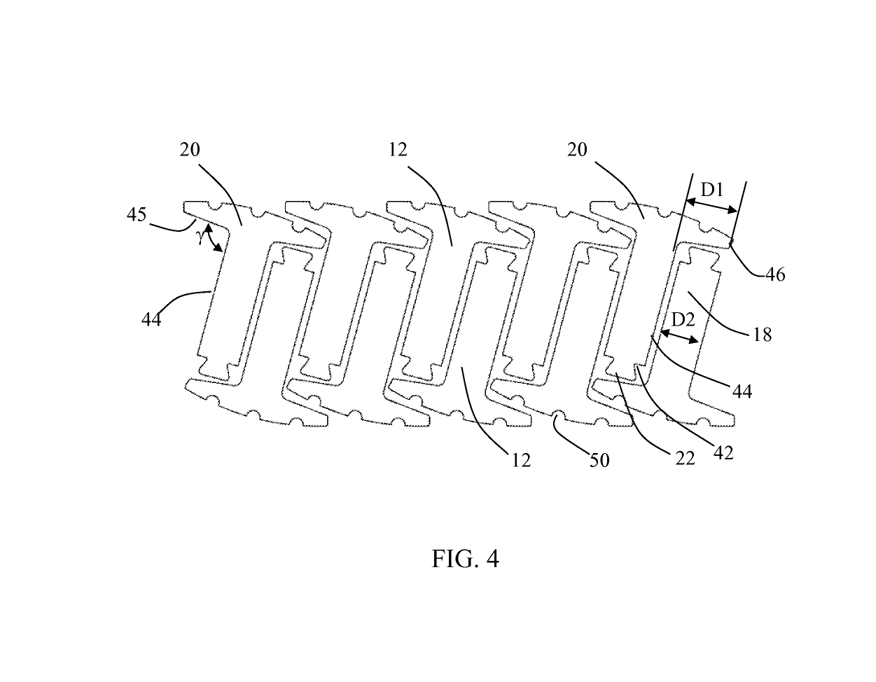

FIG. 4 illustrates a production pattern for a plurality of poles 12 in accordance with some embodiments. As illustrated in FIG. 4, in each pole 12, the distance between a side surface 46 of a pole shoe 20 to a side surface 44 of a pole body 18 is denoted as D1, while the width of a pole body 18 may be denoted as D2. In accordance with some embodiments, D1 may be configured to be greater than D2. This configuration allows for two rows of poles 12 to be positioned in an alternating or interdigital pattern to achieve a more compact layout for production while leaving just enough materials between the layout patterns for machining or manufacturing processes to achieve desired final dimensions and thus reducing material consumption during manufacturing and lowering costs.

An inner surface 45 of pole shoe 20 forms an angle γ with a side surface 44 of pole body 18 in some embodiments. In some of these embodiments, angle γ may be configured to be between 100° and 120°. This configuration may allow for a more compact production configuration, increasing material utilization during manufacturing. In addition, the configuration may provide more space on the core component 10 for field coil windings, increasing slot fill ratio and the magnetic field generated by the field coil. In some embodiments, the outer surface 48 of pole shoe 20 may optionally comprise one or more indentations 50, which may function to help to reduce cogging torque in an electric motor.

In the aforementioned embodiments, poles 12 and yoke portions 14 are separate components. This may allow for easier and more convenient winding of field coils, as well as increasing utilization of the winding slot 17 between adjacent poles 12 (shown in FIG. 2A), by having the field coils wound around or otherwise attached to poles 12 before they are affixed to yoke portions 14. In some embodiments, a field coil may be wound around a coil frame or sleeve, which is placed over pole body 18 prior to attaching pole 12 to yoke portion 14.

As illustrated in FIG. 2B, when a belt component 26 is formed into a yoke 16, the outer surfaces 28 of adjacent yoke portions 14 are positioned with respect to each other at an angle α that is less than 180°. In addition or in the alternative, a portion 42 of the outer surface 28 of a yoke portion 14 defined by where pole 12 contacts the outer surface 28 of yoke portion 14 forms an angle β with a side surface 44 of pole 12. In some embodiments, angle β is configured to be substantially equal to 90°. In other embodiments, angle β may be configured to be less than 90° based at least in part upon the dimensions of one or more other components.

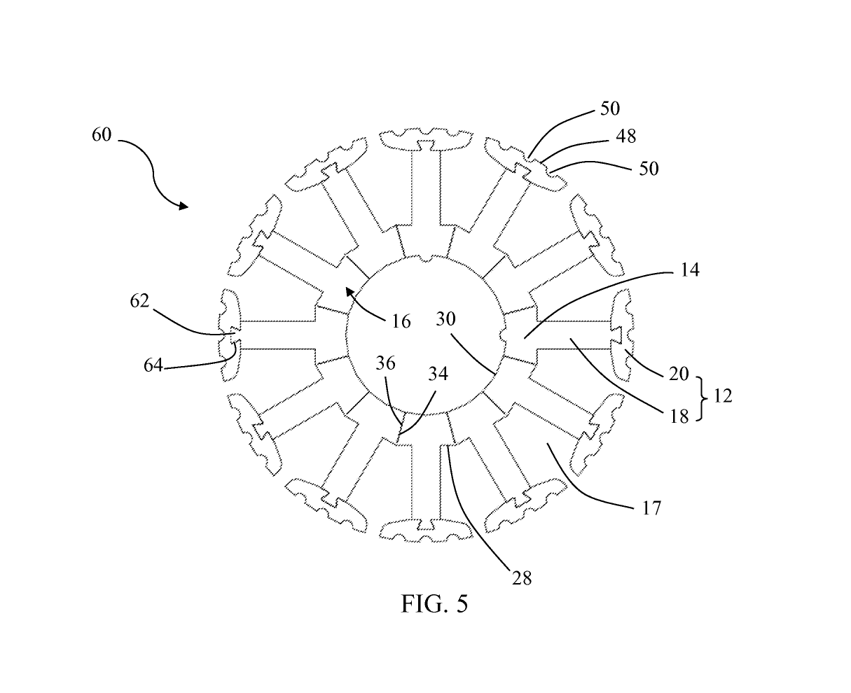

FIG. 5 illustrates a motor core component 60 in accordance with some embodiments. As with motor core component 10, motor core component 60 comprises a plurality of poles 12 and a yoke 16 comprising a plurality of yoke portions 14. Poles 12 are attached to the outside of yoke portions 14, and extend radially outwards away from the center of annular yoke 16. Adjacent pairs of poles 12 define structural features to house magnetic components, such as winding slots 17. The magnetic components may comprise field coils that are wound around or otherwise attached to the poles 12, and occupy at least some of the space in winding slots 17.

Each of pole 12 comprise a pole body 18 and a pole shoe 20, wherein the pole shoe 20 may extend circumferentially to both sides from the outer end of a corresponding pole body 18. In the illustrated embodiment, the pole bodies 18 of poles 12 are formed from the same component as yoke portions 14, while pole shoes 20 are separate components.

In some embodiments, pole body 18 and pole shoe 20 may be attached to each other through an indentation 62 and a corresponding protrusion 64 configured to fit each other. For example, in the illustrated embodiment, protrusion 64 may be formed on the outer end surface of pole body 18, while indentation 62 is formed on the inner surface of pole shoe 20. In other embodiments, other types of connection features for attaching a pole shoe 20 to a pole body 18 may be used. The mated pole body 18 and pole shoe 20 may be further secured in space by any other suitable means such as the use of retainers or fasteners.

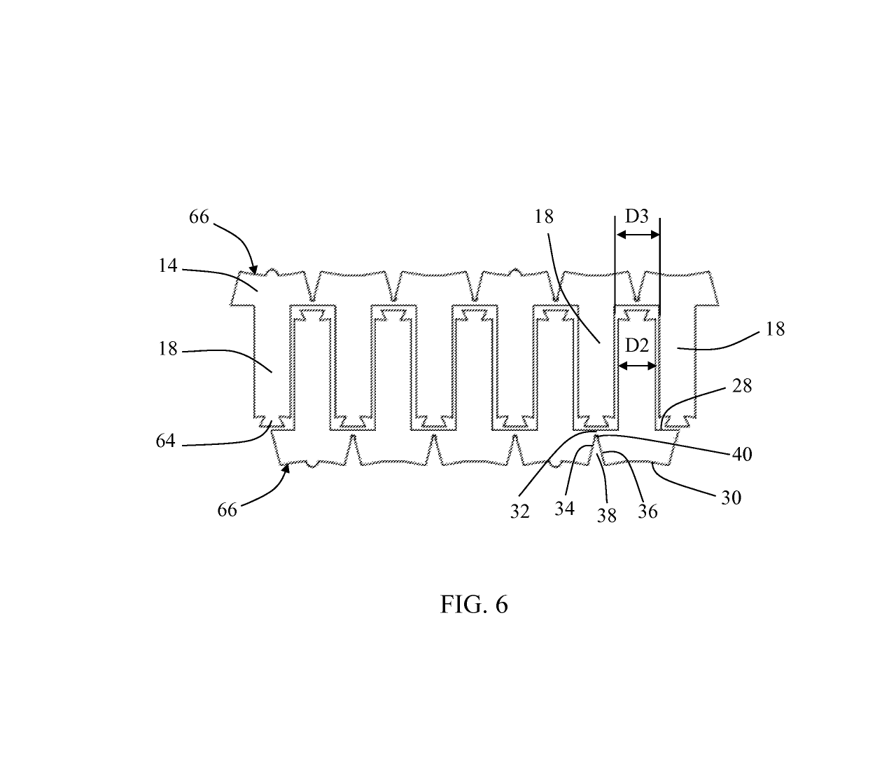

Yoke 16 of the motor core component 60 may be formed by bending, folding, rolling, or other metalworking processes to form a belt component 66, as shown in FIG. 6. In some embodiments, yoke 16 may be formed from a single belt component 66, while in other embodiments, yoke 16 is formed from two or more belt components 66 attached together. FIG. 6 illustrates a production pattern for a plurality of belt components 66. In some embodiments, belt component 66 is configured so that the plurality of yoke portions 14 and their outer surfaces 28 are positioned on the same plane, with the pole bodies 18 extending substantially perpendicular from the outer surfaces 28 of yoke portions 14. Adjacent yoke portions 14 in belt component 66 may be connected via connection portions 32 located near outer surface 28. Each pair of adjacent yoke portions 14 may be separated by a notch 38 defined by joint surfaces 34 and 36 extending from a connection portion 32 to inner surface 30. When belt component 26 is bent or folded into yoke 16, the pairs of joint surfaces 34 and 36 are made to contact each other, closing notch 38. It shall be noted that although each yoke portion 14 in FIG. 6 may appear to be identical, the plurality of yoke portions 14 do not necessarily have to be identical in some other embodiments.

In some embodiments, the inner surfaces 30 of the yoke portions 14 that comprise belt component 66 define a concave arcuate or curved segment, such that when belt component 66 is formed into a yoke 16, the inner surfaces 30 of the plurality of yoke portions 14 may define a substantially circular shape.

As illustrated in FIG. 6, the distance between adjacent pole bodies 18 in a belt component 66 in a pre-assembled state may be denoted by D3, while the width of a pole body 18 is denoted as D2. In some embodiments, D3 may be configured to be greater than D2 to allow for multiple belt components 66 to be positioned in an alternating or interdigital configuration to achieve a more compact layout, reducing material consumption and lowering manufacturing costs.

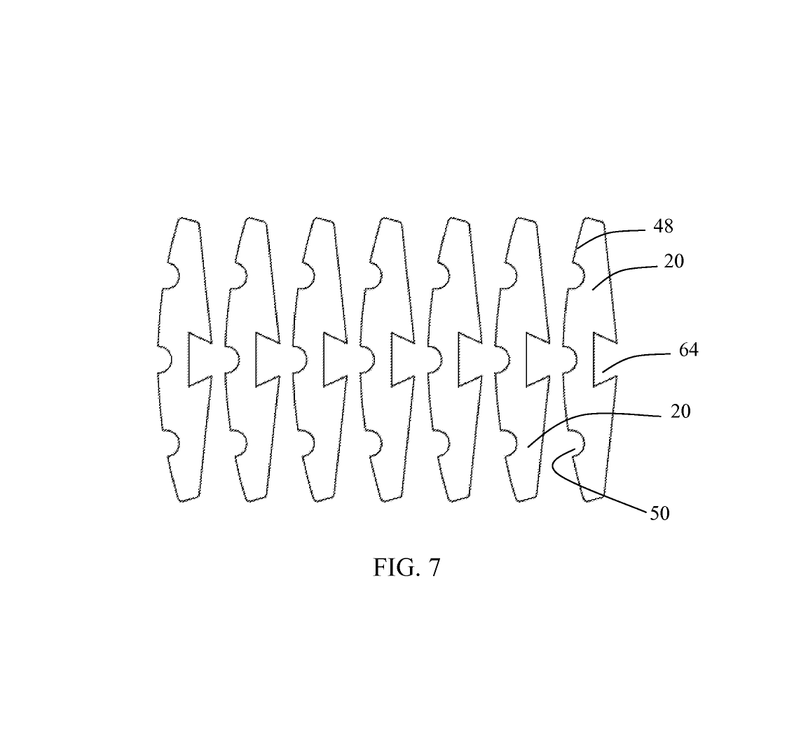

FIG. 7 illustrates another production pattern for a plurality of pole shoes 20 for a motor core component 60 in accordance with some embodiments. In some embodiments, an outer surface 48 of pole shoe 20 may optionally comprises one or more indentations or cutouts 50, which may help to reduce cogging torque in the motor.

In embodiments where pole body 18 comprises a separate component from the corresponding pole shoe 20, such as the motor core component 60 shown in FIG. 5, field coils may be wound around pole body 18 before pole shoe 20 is attached. This may allow for more convenient winding, as well as increasing utilization of the winding slots 17 between adjacent poles 12, as shown in FIG. 5. In some embodiments, a field coil may be wound or otherwise wrapped around a coil frame or sleeve, and the coil frame or sleeve may be placed over the pole body 18 before it is attached pole shoe 20.

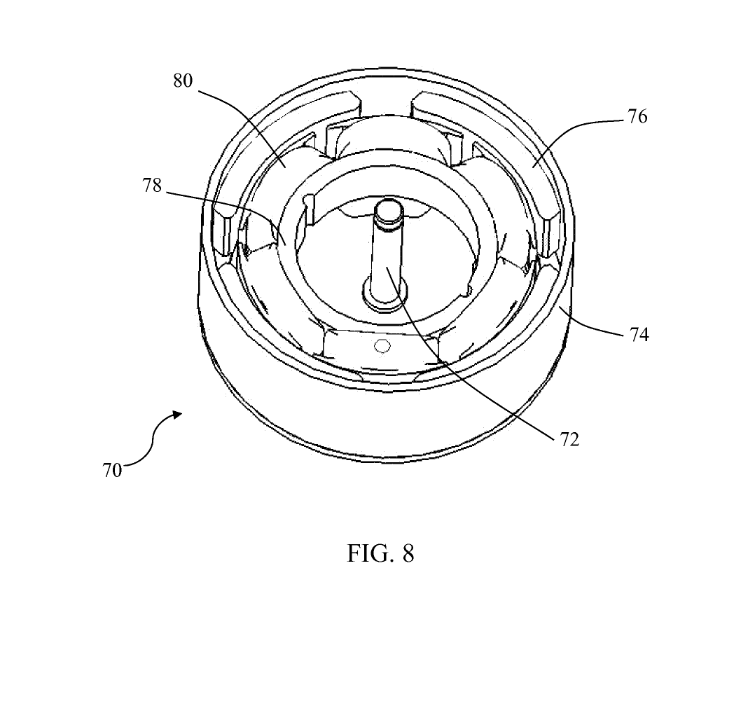

FIG. 8 illustrates a motor 70 in accordance with some embodiments. Motor 70 may be a brushed or a brushless motor, and comprises a stator and a rotor. In some embodiments, motor 70 is an inner stator/outer rotor motor.

The rotor of motor 70 may comprise an output shaft 72 affixed to a housing 74. A plurality of magnetic components 76 may be attached to housing 74. For example, FIG. 8 illustrates the magnetic components 76 attached to the inside of housing 74.

The stator of motor 70 comprises a core assembly 78, as well as a plurality of field coils 80 in the illustrated embodiments. Core assembly 78 may comprise one or more core components, such as core component 10 shown in FIG. 2A or core component 60 shown in FIG. 5, stacked together. During operation, magnetic components 76 spin around core assembly 78, and the output may be transferred through the output shaft 72 to an external application.

While the embodiments illustrated above are directed to stator core components for an inner stator/outer rotor motor, it shall be understood that those skilled in the art that the same concepts may also be applied to other types of motors or generators, such as outer stator/inner rotor motors. For example, in some embodiments, the outer surface 28 of yoke portions 14 may define a convex arcuate or curved segment, while inner surface 30 may have one or more structural features, such as slots 24, for attaching a pole 12 to the inside of yoke 16.

In the foregoing specification, various aspects have been described with reference to specific embodiments thereof. It will, however, be evident that various modifications and changes may be made thereto without departing from the broader spirit and scope of various embodiments described herein. For example, the above-described systems or modules are described with reference to particular arrangements of components. Nonetheless, the ordering of or spatial relations among many of the described components may be changed without affecting the scope or operation or effectiveness of various embodiments described herein. In addition, although particular features have been shown and described, it will be understood that they are not intended to limit the scope of the claims or the scope of other embodiments, and it will be clear to those skilled in the art that various changes and modifications may be made without departing from the scope of various embodiments described herein. The specification and drawings are, accordingly, to be regarded in an illustrative or explanatory rather than restrictive sense. The described embodiments are thus intended to cover alternatives, modifications, and equivalents.

1. A core component for an electric motor, comprising:
a yoke formed from at least one belt component comprising a plurality of yoke portions in linear connection;
a plurality of pole bodies extending radially from the plurality of yoke portions; and
a plurality of pole shoes extending circumferentially outward from ends of the plurality of pole bodies remote from the plurality of yoke portions, wherein the plurality of pole shoes and the plurality of yoke portions constitute separate components.

2. The core component of claim 1, wherein an inner surface of a pole shoe of the plurality of pole shoes and a side edge of a pole body of the plurality of pole bodies are disposed at an angle between 100° to 120°.

3. The core component of claim 1, wherein a circumferential length that a pole shoe of the plurality of pole shoes extends away from a pole body of the plurality of pole bodies is greater than a width of the pole body.

4. The core component of claim 1, wherein a distance between two adjacent pole bodies of the plurality of pole bodies is greater than a width of a pole body of the plurality of pole bodies.

5. The core component of claim 1, wherein the plurality of pole bodies are integrally formed with the plurality of pole shoes and constitute separate components from the plurality of yoke portions.

6. The core component of claim 5, wherein:
a yoke portion of plurality of yoke portions in the at least one belt component has a first connection feature formed therein; and
a pole body of the plurality of pole bodies has a second connection feature at an end near the yoke portion mated with the first connection feature of the yoke portion.

7. The core component of claim 1, wherein:
the plurality of pole bodies are integrally formed with the plurality of yoke portions and constitute separate components with the plurality of pole shoes;
a pole body of the plurality of pole bodies has a first connection feature at an end remote from a corresponding one of the plurality of yoke portions; and
a pole shoe of the plurality of pole shoes has a second connection feature mated with the first connection structure on the pole body.

8. The core component of claim 1, wherein the yoke comprises at least two belt components.

9. The core component of claim 1, further comprising a plurality of magnetic components attached to the plurality of poles bodies, wherein the plurality of magnetic components comprises multiple field coils.

10. The core component of claim 9, wherein the multiple field coils comprise an aluminum coil.

11. A method for manufacturing a core component, comprising:
identifying at least one belt component comprising a plurality of yoke portions;
forming the at least one belt component into a yoke;
identifying a plurality of poles, wherein a pole of the plurality of poles comprises a pole body and a pole shoe extending circumferentially outwards from an end of the pole body, and at least a portion of the pole constitutes a separate component from the at least one belt component;
attaching a magnetic component to the pole; and
attaching the at least a portion of the pole to the at least one belt component after attaching the magnetic component to the pole.

12. The method of claim 11, wherein identifying a plurality of poles further comprises forming an angle in a range of 100° to 120° between an inner surface of a pole shoe and an edge of a pole body.

13. The method of claim 11, wherein identifying a plurality of poles further comprises forming a pole shoe having a length extending away a pole body greater than a width of the pole body.

14. The method of claim 11, wherein identifying at least one belt component comprises forming a first belt component and a second belt component arranged such that a first plurality of pole bodies formed integrally with the first belt component and a second plurality of pole bodies formed integrally with the second belt component are arranged in an interdigital pattern.

15. The method of claim 11, wherein forming the at least one belt component into a yoke comprises bending, folding, or rolling the at least one belt component.

16. The method of claim 11, wherein attaching the at least a portion of the pole comprises mating a first connection feature on the pole body of the pole with a second connection feature on one of the plurality of yoke portions of the at least one belt component.

17. The method of claim 11, wherein identifying the plurality of poles further comprises forming the plurality of pole bodies integrally with the plurality of yoke portions of the at least one belt component and separately from the plurality of pole shoes.

18. The method of claim 17, wherein attaching the at least a portion of the pole to the at least one belt component comprises mating a connection feature on the pole shoe of the pole with a corresponding connection feature on the pole body of the pole.

19. The method of claim 11, wherein attaching a magnetic component comprises winding at least one field coil around at least one of the plurality of poles.

20. The method of claim 11, wherein identifying at least one belt component further includes identifying at least two belt components.
